(19) United States
(12) Patent Application Publication
(10) Pub. No.: US 2023/0347306 A1
(43) Pub. Date: Nov. 2, 2023

(54) Paint mixing device integrated with storage and adjustment

(71) Applicant: Zhengzhou Sanhua Technology & Industry Co., Ltd., Xingyang City (CN)

(72) Inventors: Kunkun ZHANG, Xingyang City (CN); Xianwu REN, Xingyang City (CN)

(21) Appl. No.: 18/093,830

(22) Filed: Jan. 6, 2023

(30) Foreign Application Priority Data
Apr. 29, 2022 (CN) 202221023789.9

(51) Int. Cl. B01F 33/84; B01F 35/71

(52) U.S. Cl. CPC B01F 33/84; B01F 35/7174; B01F 35/71805; B01F 2101/30

(57) ABSTRACT

The present disclosure provides a paint mixing device integrated with storage and adjustment, which includes: a cabinet body; a plurality of rows of placement racks, installed on the cabinet body, each row of the placement rack includes a plurality of placement point positions; a plurality of color master batch units, correspondingly arranged in the plurality of the placement point positions; a guide rail, an extension direction of the guide rail is consistent with an extension direction of the placement racks; a punching assembly, arranged at one end of the extension direction of the placement racks; and a mechanical arm component, herein it may be moved along a guiding direction of the guide rail, the mechanical arm component includes a longitudinal beam and a mechanical arm rocking frame, and the mechanical arm rocking frame may be swung around its own axis, and moved up and down along the longitudinal beam.

### CROSS-REFERENCE TO RELATED APPLICATION(S)

The present disclosure claims priority to Chinese Patent Application No. 202221023789.9, filed on Apr. 29, 2022 and entitled “Paint mixing device integrated with storage and adjustment”, the contents of which are hereby incorporated by reference in its entirety.

### TECHNICAL FIELD

The present disclosure relates to the technical field of paint mixing and color matching, in particular to a paint mixing device integrated with storage and adjustment.

### BACKGROUND

It is well-known, various paints, latex paints, inks or car paints are mixed with various color master batches and auxiliary materials according to formulas, and finally the paint required is obtained. In addition to the most traditional manual mixing of paint mixers, the paint mixing process may also be adjusted by various types of paint mixing devices that become more and more popular at present. The paint mixing device generally includes a plurality of color master batch storage tanks and a batching conveying module, the batching conveying module discharges color master batches in the different color master batch storage tanks according to the formulas respectively, and mixes them in a relevant container, to obtain the paint required.

In the existing market, there are more and more customers for customizing various paints and coatings, and more and more types of the color master batches are required. In the process of paint mixing, the conveying of the color master storage tank and batching are all performed manually, so that the mixing efficiency of pigments is low, and the labor cost is high.

### SUMMARY

A main purpose of the present disclosure is to provide a paint mixing device integrated with storage and mixing, which is able to achieve the automatic mixing of pigments, improve the mixing efficiency, and reduce the labor cost.

In order to achieve the above purpose, according to one aspect of the present disclosure, a paint mixing device integrated with storage and adjustment is provided, including:
a cabinet body;
a plurality of rows of placement racks, installed on the cabinet body from top to bottom, herein each row of the placement rack includes a plurality of placement point positions;
a plurality of color master batch units, correspondingly arranged in the plurality of the placement point positions;
a guide rail, arranged on the cabinet body, herein an extension direction of the guide rail is consistent with an extension direction of the each row of the placement rack;
a punching assembly, located in the cabinet body, and arranged at an end of the extension direction of the placement racks; and
a mechanical arm component, herein the mechanical arm component is configured to be moved along a guiding direction of the guide rail, the mechanical arm component includes a longitudinal beam and a mechanical arm rocking frame that is able to pick and place the color master batch unit, and the mechanical arm rocking frame is able to be swung around its own axis, and configured to be moved up and down along the longitudinal beam.

In some embodiments, the cabinet body is provided with a driving assembly, the driving assembly includes a first driving motor, an active belt wheel, a first synchronous belt, a passive belt wheel and a driving plate, the active belt wheel is arranged on an output end of the first driving motor, the passive belt wheel is arranged on the guide rail, the first synchronous belt is wound around the active belt wheel and the passive belt wheel, and the driving plate is fixedly arranged on the first synchronous belt, and drivingly connected with the mechanical arm component, to drive the mechanical arm component to slide along the guide rail.

In some embodiments, the mechanical arm component further includes a mechanical arm cross beam, the mechanical arm cross beam is provided with a lateral moving roller, and the mechanical arm cross beam is slidably arranged on the guide rail by the lateral moving roller.

In some embodiments, the lateral moving roller includes support wheels and lateral guide wheels, the support wheels are installed on two ends of the mechanical arm cross beam to form a support for the mechanical arm cross beam, the lateral guide wheel is located on two ends of at least one support wheel of the mechanical arm cross beam to form a limiting space, and the guide rail is located in the limiting space.

In some embodiments, the mechanical arm component further includes a first linear guide rail, a first linear slider, a longitudinal fixing block and a mechanical arm rotating seat plate, wherein the first linear guide rail is arranged on the longitudinal beam and extends in an up-down direction, the first linear slider is slidably arranged on the first linear guide rail, the longitudinal fixing block is fixedly installed on the first linear slider, the mechanical arm rotating seat plate is installed on the longitudinal fixing block, and the mechanical arm rocking frame is installed on the mechanical arm rotating seat plate.

In some embodiments, the mechanical arm component further includes a rotating motor, a motor shaft of the rotating motor is located under the mechanical arm rotating seat plate, the mechanical arm rotating seat plate is provided with a first rotating shaft, an output end of the rotating motor is provided with a synchronous wheel, the first rotating shaft is in transmission with the synchronous wheel by a second synchronous belt, the first rotating shaft is fixedly connected with a transverse screw rod base, the transverse screw rod base is provided with a transverse screw rod assembly, a second driving motor, a second linear guide rail, a second linear slider, a motor fixing plate and a swing motor, a guiding direction of the second linear guide rail is the same as an orientation of the transverse screw rod assembly, the second linear slider is slidably arranged on the second linear guide rail, the motor fixing plate is arranged on the second linear slider, the swing motor is arranged on the motor fixing plate, and the mechanical arm rocking frame is arranged on a motor shaft of the swing motor.

In some embodiments, the mechanical arm component further includes a longitudinal driving assembly, the longitudinal driving assembly includes a longitudinal driving motor, a chain wheel, a driving chain and a counterweight, the chain wheel is arranged on a motor shaft of the longitudinal driving motor, the driving chain is installed on the chain wheel, an end of the driving chain is fixedly connected with the counterweight, and the other end of the driving chain is fixedly connected with the first linear guide rail.

In some embodiments, each color master batch unit includes a fixing bottom plate, a multi-way valve and a plunger pump, the multi-way valve is arranged on the fixing bottom plate, the plunger pump is arranged on the fixing bottom plate, and communicated with the multi-way valve, and a feeding port of the multi-way valve is provided with a color master batch barrel, and the color master batch barrel is replaceably.

In some embodiments, the punching assembly includes a punching mechanism bottom plate, a ball screw rod assembly and a lifting card, the ball screw rod assembly is arranged on the punching mechanism bottom plate, the lifting card is arranged on a driving screw nut of the ball screw rod assembly, the plunger pump includes a pump rod head, the ball screw rod assembly is detachably connected with the plunger pump, and the lifting card is able to drive the pump rod head to move up and down, so a color master batch in the color master batch barrel is quantitatively injected out by the multi-way valve.

In some embodiments, the paint mixing device further includes a palette assembly, the palette assembly is arranged on a side, facing the mechanical arm component, of the punching assembly, the palette assembly includes a color master batch barrel fixing seat, a second rotating shaft, a rotary motor, a turntable and a color master batch barrel fixing frame, the color master batch barrel fixing seat is fixedly connected to the punching assembly, the turntable is installed on the second rotating shaft and configured be rotated with the second rotating shaft, the rotary motor is installed on the color master batch barrel fixing seat, the second rotating shaft is in transmission with an output shaft of the rotary motor by a transmission belt, and the color master batch barrel fixing frame is arranged on the turntable.

Applying the technical scheme of the present disclosure, by arranging the mechanical arm component, the plurality of rows of the placement racks, the cabinet body, the color master batch units, and the guide rail, during mixing, the mechanical arm component is able to move along the slide rail and the longitudinal beam successively, until the mechanical arm component is moved to a position in which the color master batch unit to be grabbed is located, and then the color master batch unit required is taken out by the mechanical arm rocking frame, and conveyed to the punching assembly for a punching operation. The above process does not require a manual operation, which is configured to achieve the automatic mixing of the pigments, improve the mixing efficiency, and reduce the labor cost.

### BRIEF DESCRIPTION OF THE DRAWINGS

Drawings of the description constituting a part of the present disclosure are used to provide further understanding of the present disclosure, schematic embodiments of the present disclosure and descriptions thereof are used to explain the present disclosure, and do not constitute improper limitation to the present disclosure. In the drawings:

FIG. 1 shows an overall structure schematic diagram of a paint mixing device integrated with storage and adjustment according to an embodiment of the present disclosure.

FIG. 2 shows a partial structure schematic diagram of a paint mixing device integrated with storage and adjustment according to an embodiment of the present disclosure.

FIG. 3 shows a partial enlarged view at a part A of FIG. 2.

FIG. 4 shows a partial enlarged view at a part B of FIG. 2.

FIG. 5 shows a structure schematic diagram of a mechanical arm component of the paint mixing device integrated with the storage and adjustment according to an embodiment of the present disclosure.

FIG. 6 shows a partial enlarged view at a part C of FIG. 5.

FIG. 7 shows a structure schematic diagram in another angle of the mechanical arm component of the paint mixing device integrated with the storage and adjustment according to another embodiment of the present disclosure.

FIG. 8 shows a partial enlarged view at a part D of FIG. 7.

FIG. 9 shows a partial enlarged view at a part E of FIG. 7.

Herein, the above drawings include the following reference signs.

10. Cabinet body; 11. Placement rack; 12. Color master batch unit; 13. Guide rail; 14. Longitudinal beam; 15. Mechanical arm rocking frame; 16. First driving motor; 17. Active belt wheel; 18. First synchronous belt; 19. Passive belt wheel; 20. Driving plate; 21. Mechanical arm cross beam; 22. Lateral moving roller; 23. Support wheel; 24. Lateral guide wheel; 25. First linear slider; 26. Longitudinal fixing block; 27. Mechanical arm rotating seat plate; 28. Rotating motor; 29. First rotating shaft; 30. Synchronous wheel; 31. Second synchronous belt; 32. Transverse screw rod base; 33. Transverse screw rod assembly; 34. Second driving motor; 35. Second linear slider; 36. Motor fixing plate; 37. Swing motor; 38. Longitudinal driving motor; 39. Chain wheel; 40. Driving chain; 41. Counterweight; 42. Fixing bottom plate; 43. Multi-way valve; 44. Plunger pump; 45. Color master batch barrel; 46. Punching mechanism bottom plate; 47. Ball screw rod assembly; 48. Lifting card; 49. Color master batch barrel fixing seat; 50. Second rotating shaft; 51. Rotary motor; 52. Turntable; 53. Color master batch barrel fixing frame; 54. Transmission belt; 55. Electronic scale; 56. Pump rod head; 57. Palette assembly; 58. First linear guide rail; and 59. Second linear guide rail.

### DETAILED DESCRIPTION OF THE EMBODIMENTS

It should be noted that embodiments of the present disclosure and features of the embodiments may be combined with each other in the case without conflicting. The present disclosure is described in detail below with reference to the drawings and in combination with the embodiments.

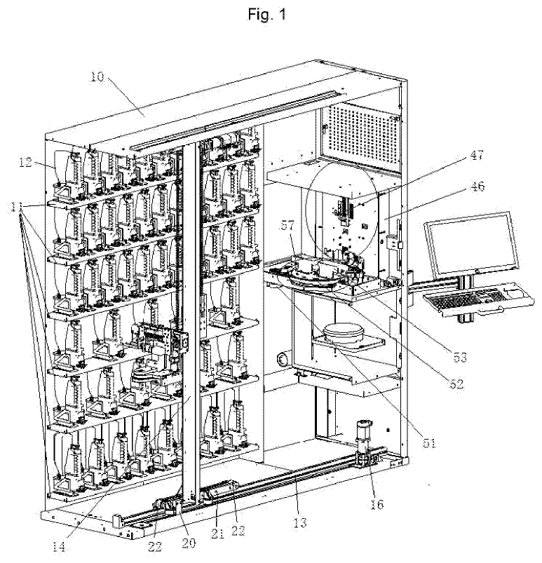

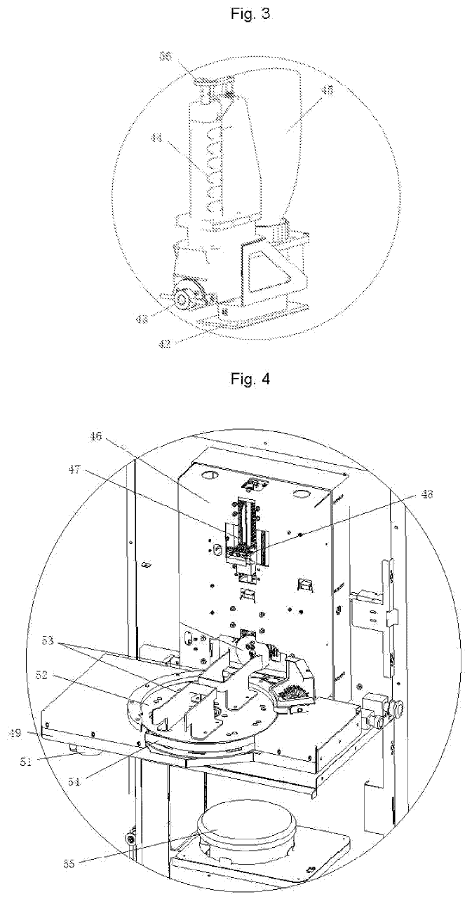

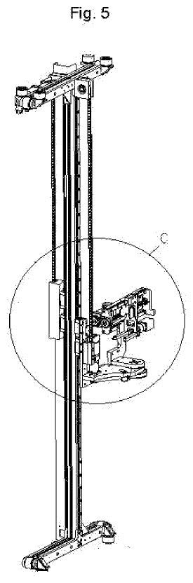

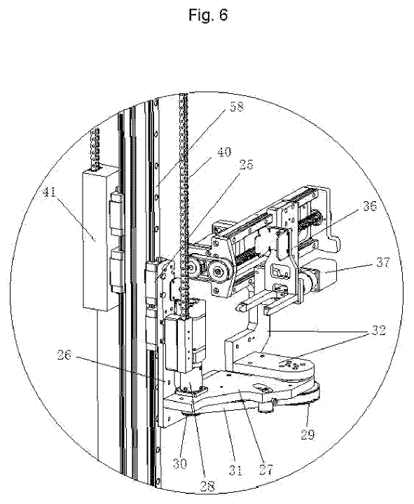

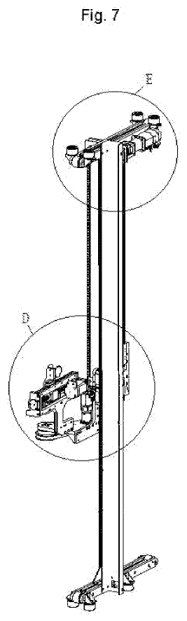

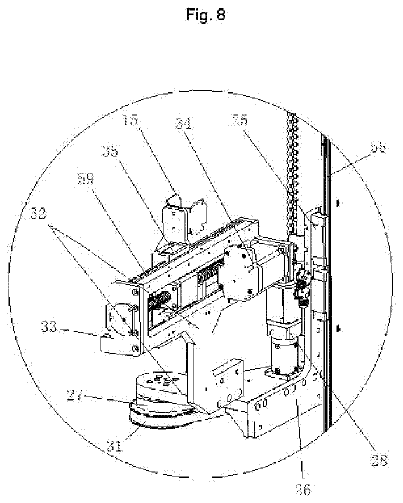

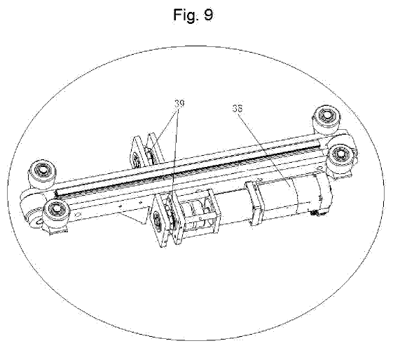

Referring to FIG. 1 to FIG. 9, the present disclosure provides a paint mixing device integrated with storage and adjustment, including: a cabinet body 10; a plurality of rows of placement racks 11, installed on the cabinet body 10 from top to bottom, herein each row of the placement rack 11 includes a plurality of placement point positions; a plurality of color master batch units 12, correspondingly arranged in the plurality of the placement point positions; a guide rail 13, arranged on the cabinet body 10, herein an extension direction of the guide rail 13 is consistent with an extension direction of the each row of the placement rack 11; a punching assembly, located in the cabinet body 10, and arranged at an end of the extension direction of the placement racks 11; and a mechanical arm component, herein the mechanical arm component is configured to be moved along a guiding direction of the guide rail 13, the mechanical arm component includes a longitudinal beam 14 and a mechanical arm rocking frame 15 that is able to pick and place the color master batch unit 12, and the mechanical arm rocking frame 15 is able to be swung around its own axis, and configured to be moved up and down along the longitudinal beam 14.

In the above technical scheme, the point position of the color master batch unit 12 is (m, n), the driving motor firstly drives the mechanical arm component to move to a position m along an axis of the guide rail 13 according to a control signal sent by a control device, and then drives the mechanical arm component to move up and down along the longitudinal beam 14, until the mechanical arm component is moved to a position n. While the mechanical arm component is moved to a position in which the color master batch unit 12 is located, a rotating motor 28 rotates and drives a second synchronous belt 31 by a synchronous wheel 30, the second synchronous belt 31 drives a first rotating shaft 29 to rotate, and the first rotating shaft 29 drives a transverse screw rod assembly 33 on a transverse screw rod base 32 to rotate. While the transverse screw rod assembly 33 rotates so that a second linear slider 35 on a second linear guide rail 59 is moved relative to the color master batch unit 12, a second driving motor 34 rotates, and drives the transverse screw rod assembly 33 to drive the second linear slider 35 on the second linear guide rail 59 to move, so that the mechanical arm rocking frame 15 is close to the color master batch unit 12, and finally inserted and locked on both sides of a fixing bottom plate 42 and a plunger pump 44 in the color master batch unit 12, and it is able to grab the color master batch unit 12. The control device sends out the control signal, the driving assembly drives a first linear slider 25 to upwards move to a safe height along a first linear guide rail 58, and then the second driving motor 34 rotates reversely, and drives the transverse screw rod assembly 33 to drive the second linear slider 35 on the second linear guide rail 59 to move, so that the mechanical arm rocking frame 15 leaves the placement rack 11. At the same time, the rotating motor 28 rotates reversely, so that a moving direction of the second linear guide rail 59 on the transverse screw rod assembly 33 is parallel to the placement rack 11, the longitudinal beam 14 is moved along the guide rail 13 by the driving of a first driving motor 16 and gradually approaches a palette assembly 57, and then the color master batch unit 12 is inserted into the color master batch barrel fixing frame 53 in the palette assembly 57, and the driving motor drives the mechanical arm component to move along the guiding direction of the guide rail 13 to a place towards the palette assembly 57, until the color master batch unit 12 is sent into the color master batch barrel fixing frame 53. The mechanical arm component is moved downwards in a distance along the longitudinal beam 14, until the mechanical arm rocking frame 15 is separated from the color master batch unit 12, and then the mechanical arm component is moved in a direction away from the palette assembly 57, the palette assembly 57 rotates to send the color master batch unit 12 to the punching assembly for feeding. While the punching of one color master batch is finished, the color master batch unit 12 is placed in its original placement point position, and then the next color master batch unit 12 is grabbed to perform the punching, thereby the automatic mixing of the pigments is achieved, the mixing efficiency is improved, and the labor cost is reduced.

In addition, if it is necessary to uniformly mix the color master batches in a color master batch barrel 45, a swing motor 37 on the mechanical arm rocking frame 15 is able to be controlled by a program, to frequently perform forward and reverse rotation, so that the color master batches in the color master batch barrel 45 are mixed uniformly, to prevent the color master batches from precipitating.

It should be noted that, in an embodiment of the present disclosure, the paint mixing device integrated with the storage and adjustment is further provided with a control device and an electronic scale 55, the control device may cooperate with the mechanical arm component, to take out the required color master batch units 12 located in the different placement point positions of the placement racks 11, and the control device contains information of the color master batch unit 12 corresponding to each placement point position, as to know the position of each color master batch unit 12, and accurately control the mechanical arm component to take or re-position the relevant color master batch unit 12. An electronic signal of the electronic scale 55 is transmitted to the control device, and by a closed-loop control, the feeding amount of different materials/color master batches is able to be completed.

According to an acquired formula of a mixture to be synthesized, the mechanical arm component takes out the color master batch unit 12 for synthesizing necessary components of the mixture from the placement rack 11 for many times, and then sends the color master batch unit 12 to the color master batch barrel fixing frame 53, a rotary motor 51 on the palette assembly 57 drives the color master batch unit 12 to the punching assembly for punching, and the required material/color master batch is injected into a mixing container placed on the electronic scale 55, and the above operation is repeated many times, until all of the materials/color master batches are injected according to the formula. In addition, after the use of a certain color master unit 12 is completed, the mechanical arm component also needs to take down the color master batch unit 12 from the palette assembly 57, and put it back to the original placement point position on the placement rack 11.

Referring to FIG. 1 to FIG. 9, in an embodiment of the present disclosure, the cabinet body 10 is provided with a driving assembly, the driving assembly includes a first driving motor 16, an active belt wheel 17, a first synchronous belt 18, a passive belt wheel 19 and a driving plate 20, the active belt wheel 17 is arranged on an output end of the first driving motor 16, the passive belt wheel 19 is arranged on the guide rail 13, the first synchronous belt 18 is wound around the active belt wheel 17 and the passive belt wheel 19, and the driving plate 20 is fixedly arranged on the first synchronous belt 18, and drivingly connected with the mechanical arm component, to drive the mechanical arm component to slide along the guide rail 13; and the mechanical arm component further includes a mechanical arm cross beam 21, the mechanical arm cross beam 21 is provided with a lateral moving roller 22, and the mechanical arm cross beam 21 is slidably arranged on the guide rail 13 by the lateral moving roller 22.

In the above technical solutions, a connecting line between the active belt wheel 17 and the passive belt wheel 19 is parallel to the axis of the guide rail 13, the first synchronous belt 18 is wound around the active belt wheel 17 and the passive belt wheel 19, and the first synchronous belt 18 is fixedly provided with the driving plate 20. The other end of the driving plate 20 is connected with the mechanical arm cross beam 21. While the first driving motor 16 is started, the active belt wheel 17 is moved and drives the passive belt wheel 19 to move. Because the first synchronous belt 18 is wound around the active belt wheel 17 and the passive belt wheel 19, the first synchronous belt 18 is also moved, and drives the driving plate 20 to move leftwards and rightwards along the axis of the guide rail 13. The mechanical arm cross beam 21 is slidably arranged on the guide rail 13 by the lateral moving roller 22, so the mechanical arm cross beam 21 may be moved leftwards and rightwards along the axis of the guide rail 13 under the driving of the driving plate 20, thereby the horizontal movement of the mechanical arm component on the guide rails 13 is achieved.

It should be noted that, in an embodiment of the present disclosure, the other end of the driving plate 20 is able to be connected with the mechanical arm cross beam 21, or configured to be connected with other fixing assemblies in the mechanical arm component.

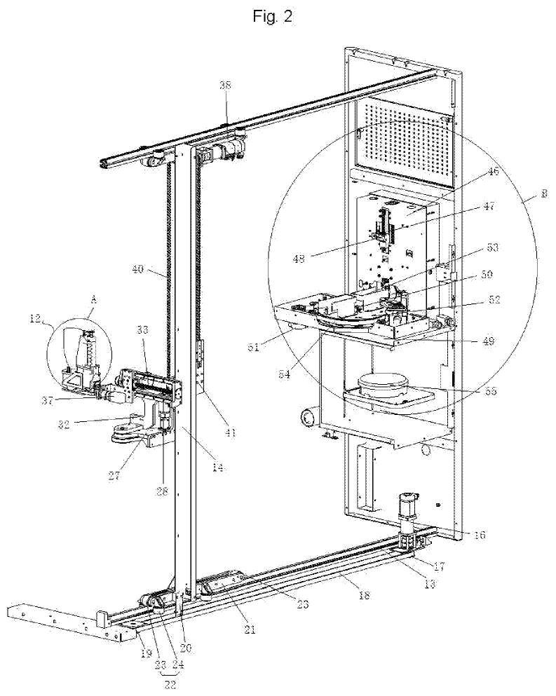

Referring to FIG. 1 and FIG. 2, in an embodiment of the present disclosure, the lateral moving roller 22 includes support wheels 23 and lateral guide wheels 24, the support wheels 23 are installed on two ends of the mechanical arm cross beam 21 to form a support for the mechanical arm cross beam 21, the lateral guide wheels 24 are located on two ends of at least one support wheel 23 of the mechanical arm cross beam 21 to form a limiting space, and the guide rail 13 is located in the limiting space.

In the above technical solution, the support wheels 23 are installed on the two ends of the mechanical arm cross beam 21 to form the support for the mechanical arm cross beam 21, and the lateral guide wheels 24 are located on the two ends of the support wheel 23 of the mechanical arm cross beam 21, to prevent the mechanical arm cross beam 21 from detaching from the guide rail 13.

Referring to FIG. 1 to FIG. 9, in an embodiment of the present disclosure, the mechanical arm component further includes the first linear guide rail 58, the first linear slider 25, a longitudinal fixing block 26 and a mechanical arm rotating seat plate 27, the first linear guide rail 58 is arranged on the longitudinal beam 14 and extends in an up-down direction, the first linear slider 25 is slidably arranged on the first linear guide rail 58, the longitudinal fixing block 26 is fixedly installed on the first linear slider 25, the mechanical arm rotating seat plate 27 is installed on the longitudinal fixing block 26, and the mechanical arm rocking frame 15 is installed on the mechanical arm rotating seat plate 27.

In the above technical solution, while the first linear slider 25 is moved along an extension direction of the first linear guide rail 58, it is able to drive the longitudinal fixing block 26 to move along the extension direction of the first linear guide rail 58. Because the mechanical arm rotating seat plate 27 is installed on the longitudinal fixing block 26, and the mechanical arm rocking frame 15 is installed on the mechanical arm rotating seat plate 27, under the driving of the longitudinal fixing block 26, the mechanical arm rotating seat plate 27 and the mechanical arm rocking frame 15 are also configured to be moved along the extension direction of the first linear guide rail 58, it is convenient for the mechanical arm rocking frame 15 to perform a grabbing operation on the color master batch units 12 in the different positions.

Referring to FIG. 1 to FIG. 9, in an embodiment of the present disclosure, the mechanical arm component further includes the rotating motor 28, a motor shaft of the rotating motor 28 is located under the mechanical arm rotating seat plate 27, the mechanical arm rotating seat plate 27 is provided with the first rotating shaft 29, an output end of the rotating motor 28 is provided with the synchronous wheel 30, the first rotating shaft 29 is in transmission with the synchronous wheel 30 by the second synchronous belt 31, the first rotating shaft 29 is fixedly connected with the transverse screw rod base 32, the transverse screw rod base 32 is provided with the transverse screw rod assembly 33, the second driving motor 34, the second linear guide rail 59, the second linear slider 35, a motor fixing plate 36 and a swing motor 37, a guiding direction of the second linear guide rail 59 is the same as an orientation of the transverse screw rod assembly 33, the second linear slider 35 is slidably arranged on the second linear guide rail 59, the motor fixing plate 36 is arranged on the second linear slider 35, the swing motor 37 is arranged on the motor fixing plate 36, and the mechanical arm rocking frame 15 is arranged on a motor shaft of the swing motor 37.

In the above technical solution, while the rotating motor 28 works, the synchronous wheel 30 rotates, and under the driving of the second synchronous belt 31, the first rotating shaft 29 rotates with the synchronous belt, thereby the transverse screw rod base 32 is driven to rotate; the second linear slider 35 is able to slide along the second linear guide rail 59, since the motor fixing plate 36 is arranged on the second linear slider 35, while the second linear slider 35 slides along the second linear guide rail 59, the motor fixing plate 36 also slides with the second linear slider 35 along the second linear guide rail 59, the motor fixing plate 36 is able to drive the swing motor 37 and the mechanical arm rocking frame 15 to slide along the second linear guide rail 59, and while the motor fixing plate 36 slides to an end, adjacent to the output shaft of the second driving motor 34, of the second linear slide rail, under the driving of the second driving motor 34, the mechanical arm rocking frame 15 is able to extend along the extension direction of the second linear slide rail, as to grab the color master batch unit 12 by inserting and locking.

It should be noted that, in an embodiment of the present disclosure, the mechanical arm rotating seat plate 27 is provided with a bearing, and the first rotating shaft 29 is inside the bearing.

Referring to FIG. 1 to FIG. 9, in an embodiment of the present disclosure, the mechanical arm component further includes a longitudinal driving assembly, the longitudinal driving assembly includes a longitudinal driving motor 38, a chain wheel 39, a driving chain 40 and a counterweight 41, the chain wheel 39 is arranged on a motor shaft of the longitudinal driving motor 38, the driving chain 40 is installed on the chain wheel 39, an end of the driving chain 40 is fixedly connected with the counterweight 41, and the other end of the driving chain 40 is fixedly connected with the first linear guide rail 58.

In the above technical solution, the driving chain 40 crosses and is engaged with two chain wheels 39, an end of the driving chain 40 is fixedly connected with the counterweight 41, and the other end of the driving chain 40 is fixedly connected with the first linear guide rail 58. In this way, under the driving of forward and reverse rotation of the driving motor, the chain wheels 39 are able to drive the driving chain 40 to move along the extension direction of the first linear slide rail. Since the chain is connected with the longitudinal fixing block 26, and the longitudinal fixing block 26 is fixedly installed on the first linear slider 25, under the driving of the chain, the longitudinal fixing block 26, the mechanical arm rotating seat plate 27 installed on the longitudinal fixing block 26 and the mechanical arm rocking frame 15 installed on the mechanical arm rotating seat plate 27 are all able to be moved along the extension direction of the first linear slide rail, and it is convenient for the mechanical arm rocking frame 15 to grab the color master batch units 12 in the different positions.

Referring to FIG. 1 to FIG. 9, in an embodiment of the present disclosure, the color master batch unit 12 includes a fixing bottom plate 42, a multi-way valve 43 and a plunger pump 44, the multi-way valve 43 is arranged on the fixing bottom plate 42, the plunger pump 44 is arranged on the fixing bottom plate 42, and communicated with the multi-way valve 43, and a feeding port of the multi-way valve 43 is provided with a color master batch barrel 45, and the color master batch barrel 45 is replaceably; and the punching assembly includes a punching mechanism bottom plate 46, a ball screw rod assembly 47 and a lifting card 48, the ball screw rod assembly 47 is arranged on the punching mechanism bottom plate 46, the lifting card 48 is arranged on a driving screw nut of the ball screw rod assembly 47, the plunger pump 44 includes a pump rod head 56, the ball screw rod assembly 47 is detachably connected with the plunger pump 44, and the lifting card 48 is able to drive the pump rod head 56 to move up and down, so a color master batch in the color master batch barrel 45 is quantitatively injected out by the multi-way valve 43.

In the above technical solution, while the ball screw rod assembly 47 and the plunger pump 44 are in a connected state, the lifting card 48 is able to drive the pump rod head 56 to move up and down, so that the color master batch in the color master batch barrel 45 is quantitatively injected out from the multi-way valve 43.

In an embodiment of the present disclosure, the punching mechanism bottom plate 46 is further provided with a valve motor assembly, the valve motor assembly is able to drive a core shaft of the multi-way valve 43 to rotate, so as to change a working state of the multi-way valve 43 for color slurry injection or color slurry suction, and cooperate with the ball screw rod assembly 47 to complete feeding and punching processes.

Referring to FIG. 1 to FIG. 4, in an embodiment of the present disclosure, the paint mixing device further includes the palette assembly 57, the palette assembly 57 is arranged on a side, facing the mechanical arm component, of the punching assembly, the palette assembly 57 includes a color master batch barrel fixing seat 49, a second rotating shaft 50, the rotary motor 51, a turntable 52 and the color master batch barrel fixing frame 53, the color master batch barrel fixing seat 49 is fixedly connected to the punching assembly, the turntable 52 is installed on the second rotating shaft 50 and is able to be rotated with the second rotating shaft 50, the rotary motor 51 is installed on the color master batch barrel fixing seat 49, the second rotating shaft 50 is in transmission with an output shaft of the rotary motor 51 by a transmission belt 54, and the color master batch barrel fixing frame 53 is arranged on the turntable 52.

In the above technical solution, the rotary motor 51 and the second rotating shaft 50 are installed on the color master batch barrel fixing seat 49, and the second rotating shaft 50 is in transmission with the output shaft of the rotary motor 51 by the transmission belt 54. Under the driving of the rotary motor 51, the second rotating shaft 50 rotates and is able to drive the turntable 52 to rotate. Since the color master batch barrel fixing frame 53 is arranged on the turntable 52, the color master batch barrel fixing frame 53 is also rotated with the turntable 52, thereby a placement direction of the color master batch barrel 45 is changed, and it is convenient for performing the punching operation on the color master batch barrel 45.

It should be noted that, in an embodiment of the present disclosure, the color master batch fixing frames 53 are arranged in pairs, as to reduce the waiting time for conversion of one color master batch to another color master batch during the mixing process. A feeding space is reserved between the punching assembly and the palette assembly 57, and the electronic scale 55 is located below the feeding space.

In some embodiments, the working process of the paint mixing device integrated with the storage and adjustment is as follows: the point position of the required color master batch unit 12 is (m, n), and according to the control signal sent by the control device, the first driving motor 16 drives the mechanical arm component to move to the position m along the axis of the guide rail 13, and then the driving assembly drives the first linear slider 25 to move to the position n along the first linear guide rail 58. The second driving motor 34 in the transverse screw rod assembly 33 works to drive the mechanical arm rocking frame 15 to stretch forward, and grab the required color master batch unit 12, and then the control device sends out the control signal, the driving assembly drives the first linear slider 25 to move upwards to a safe height along the first linear guide rail 58, and then the second driving motor 34 is controlled to move reversely. At the same time, the driving assembly drives the first linear slider 25 to move in a distance in a vertical direction along the first linear guide rail 58. At this time, the rotating motor 28 on the mechanical arm rotating base plate 27 works according to the control signal, by the transmission of the second synchronous belt 31, the transverse screw rod base 32 and each component installed on it are driven to rotate by 90°, so that the color master batch unit 12 corresponds to each installing and locking point on the color master batch barrel fixing frame 53; the first driving motor 16 then drives the mechanical arm component to move towards the palette assembly 57 along the axis of the guide rail 13, until the color master batch unit 12 is sent into the color master batch barrel fixing frame 53; the longitudinal driving motor 38 drives the first linear slider 25 to move downwards in a distance along the first linear guide rail 58, until the mechanical arm rocking frame 15 is separated from the color master batch unit 12; then the mechanical arm component is moved in a direction away from the palette assembly 57, the turntable 52 rotates, and the color master batch unit 12 is sent to the punching assembly for feeding; and while the punching of a material/color master batch is finished, the above actions are performed reversely, to put the color master batch unit 12 back to the original placement point position, and then the next color master batch unit 12 is grabbed for punching.

From the above descriptions, it may be seen that the above embodiments of the present disclosure achieve the following technical effects: by arranging the mechanical arm component, the plurality of rows of the placement racks, the cabinet body, the color master batch units, and the guide rail, during mixing, the mechanical arm component is able to move along the slide rail and the longitudinal beam successively, until the mechanical arm component is moved to a position in which the color master batch unit to be grabbed is located, and then the color master batch unit required is taken out by the mechanical arm rocking frame, and conveyed to the punching assembly for a punching operation. The above process does not require a manual operation, which is able to achieve the automatic mixing of the pigments, improve the mixing efficiency, and reduce the labor cost.

Apparently, the above embodiments are only a part of the embodiments of the present disclosure, but not all of the embodiments. Based on the embodiments of the present disclosure, all other embodiments obtained by those of ordinary skill in the art without creative work shall fall within a scope of protection of the present disclosure.

It should be noted that terms used herein are for the purpose of describing the specific embodiments only, and are not intended to limit the exemplary embodiments according to the present application. As used herein, unless expressly specified otherwise in the context, a singular form is also intended to include a plural form, furthermore, it is to be understood that while terms “comprising” and/or “including” are used in this description, it is indicated that there are features, steps, operations, devices, components, and/or combinations thereof.

The above are only some embodiments of the present disclosure, and are not intended to limit the present disclosure. For those skilled in the art, the present disclosure may have various modifications and changes. Any modifications, equivalent replacements, improvements and the like made within the spirit and principle of the present disclosure shall be included in the scope of protection of the present disclosure.

What is claimed is:

1. A paint mixing device integrated with storage and adjustment, comprising:
a cabinet body;
a plurality of rows of placement racks, installed on the cabinet body from top to bottom, wherein each row of the placement rack comprises a plurality of placement point positions;
a plurality of color master batch units, correspondingly arranged in the plurality of the placement point positions;
a guide rail, arranged on the cabinet body, wherein an extension direction of the guide rail is consistent with an extension direction of the each row of the placement rack;
a punching assembly, located in the cabinet body, and arranged at an end of the extension direction of the placement racks; and
a mechanical arm component, wherein the mechanical arm component is configured to be moved along a guiding direction of the guide rail, the mechanical arm component comprises a longitudinal beam and a mechanical arm rocking frame that is able to pick and place the color master batch unit, and the mechanical arm rocking frame is able to be swung around its own axis, and configured to be moved up and down along the longitudinal beam.

2. The paint mixing device as claimed in claim 1, wherein the cabinet body is provided with a driving assembly, the driving assembly comprises a first driving motor, an active belt wheel, a first synchronous belt, a passive belt wheel and a driving plate, the active belt wheel is arranged on an output end of the first driving motor, the passive belt wheel is arranged on the guide rail, the first synchronous belt is wound around the active belt wheel and the passive belt wheel, and the driving plate is fixedly arranged on the first synchronous belt, and drivingly connected with the mechanical arm component, to drive the mechanical arm component to slide along the guide rail.

3. The paint mixing device as claimed in claim 1, wherein the mechanical arm component further comprises a mechanical arm cross beam, the mechanical arm cross beam is provided with a lateral moving roller, and the mechanical arm cross beam is slidably arranged on the guide rail by the lateral moving roller.

4. The paint mixing device as claimed in claim 3, wherein the lateral moving roller comprises support wheels and lateral guide wheels, the support wheels are installed on two ends of the mechanical arm cross beam to form a support for the mechanical arm cross beam, the lateral guide wheel is located on two ends of at least one support wheel of the mechanical arm cross beam to form a limiting space, and the guide rail is located in the limiting space.

5. The paint mixing device as claimed in claim 1, wherein the mechanical arm component further comprises a first linear guide rail, a first linear slider, a longitudinal fixing block and a mechanical arm rotating seat plate, wherein the first linear guide rail is arranged on the longitudinal beam and extends in an up-down direction, the first linear slider is slidably arranged on the first linear guide rail, the longitudinal fixing block is fixedly installed on the first linear slider, the mechanical arm rotating seat plate is installed on the longitudinal fixing block, and the mechanical arm rocking frame is installed on the mechanical arm rotating seat plate.

6. The paint mixing device as claimed in claim 5, wherein the mechanical arm component further comprises a rotating motor, a motor shaft of the rotating motor is located under the mechanical arm rotating seat plate, the mechanical arm rotating seat plate is provided with a first rotating shaft, an output end of the rotating motor is provided with a synchronous wheel, the first rotating shaft is in transmission with the synchronous wheel by a second synchronous belt, the first rotating shaft is fixedly connected with a transverse screw rod base, the transverse screw rod base is provided with a transverse screw rod assembly, a second driving motor, a second linear guide rail, a second linear slider, a motor fixing plate and a swing motor, a guiding direction of the second linear guide rail is the same as an orientation of the transverse screw rod assembly, the second linear slider is slidably arranged on the second linear guide rail, the motor fixing plate is arranged on the second linear slider, the swing motor is arranged on the motor fixing plate, and the mechanical arm rocking frame is arranged on a motor shaft of the swing motor.

7. The paint mixing device as claimed in claim 5, wherein the mechanical arm component further comprises a longitudinal driving assembly, the longitudinal driving assembly comprises a longitudinal driving motor, a chain wheel, a driving chain and a counterweight, the chain wheel is arranged on a motor shaft of the longitudinal driving motor, the driving chain is installed on the chain wheel, an end of the driving chain is fixedly connected with the counterweight, and the other end of the driving chain is fixedly connected with the first linear guide rail.

8. The paint mixing device as claimed in claim 1, wherein each color master batch unit comprises a fixing bottom plate, a multi-way valve and a plunger pump, the multi-way valve is arranged on the fixing bottom plate, the plunger pump is arranged on the fixing bottom plate, and communicated with the multi-way valve, and a feeding port of the multi-way valve is provided with a color master batch barrel, and the color master batch barrel is replaceably.

9. The paint mixing device as claimed in claim 8, wherein the punching assembly comprises a punching mechanism bottom plate, a ball screw rod assembly and a lifting card, the ball screw rod assembly is arranged on the punching mechanism bottom plate, the lifting card is arranged on a driving screw nut of the ball screw rod assembly, the plunger pump comprises a pump rod head, the ball screw rod assembly is detachably connected with the plunger pump, and the lifting card is able to drive the pump rod head to move up and down, so a color master batch in the color master batch barrel is quantitatively injected out by the multi-way valve.

10. The paint mixing device as claimed in claim 1, wherein the paint mixing device further comprises a palette assembly, the palette assembly is arranged on a side, facing the mechanical arm component, of the punching assembly, the palette assembly comprises a color master batch barrel fixing seat, a second rotating shaft, a rotary motor, a turntable and a color master batch barrel fixing frame, the color master batch barrel fixing seat is fixedly connected to the punching assembly, the turntable is installed on the second rotating shaft and is configured to be rotated with the second rotating shaft, the rotary motor is installed on the color master batch barrel fixing seat, the second rotating shaft is in transmission with an output shaft of the rotary motor by a transmission belt, and the color master batch barrel fixing frame is arranged on the turntable.

11. The paint mixing device as claimed in claim 10, wherein the cabinet body is provided with a driving assembly, the driving assembly comprises a first driving motor, an active belt wheel, a first synchronous belt, a passive belt wheel and a driving plate, the active belt wheel is arranged on an output end of the first driving motor, the passive belt wheel is arranged on the guide rail, the first synchronous belt is wound around the active belt wheel and the passive belt wheel, and the driving plate is fixedly arranged on the first synchronous belt, and drivingly connected with the mechanical arm component, to drive the mechanical arm component to slide along the guide rail.

12. The paint mixing device as claimed in claim 10, wherein the mechanical arm component further comprises a mechanical arm cross beam, the mechanical arm cross beam is provided with a lateral moving roller, and the mechanical arm cross beam is slidably arranged on the guide rail by the lateral moving roller.

13. The paint mixing device as claimed in claim 12, wherein the lateral moving roller comprises support wheels and lateral guide wheels, the support wheels are installed on two ends of the mechanical arm cross beam to form a support for the mechanical arm cross beam, the lateral guide wheel is located on two ends of at least one support wheel of the mechanical arm cross beam to form a limiting space, and the guide rail is located in the limiting space.

14. The paint mixing device as claimed in claim 10, wherein the mechanical arm component further comprises a first linear guide rail, a first linear slider, a longitudinal fixing block and a mechanical arm rotating seat plate, wherein the first linear guide rail is arranged on the longitudinal beam and extends in an up-down direction, the first linear slider is slidably arranged on the first linear guide rail, the longitudinal fixing block is fixedly installed on the first linear slider, the mechanical arm rotating seat plate is installed on the longitudinal fixing block, and the mechanical arm rocking frame is installed on the mechanical arm rotating seat plate.

15. The paint mixing device as claimed in claim 14, wherein the mechanical arm component further comprises a rotating motor, a motor shaft of the rotating motor is located under the mechanical arm rotating seat plate, the mechanical arm rotating seat plate is provided with a first rotating shaft, an output end of the rotating motor is provided with a synchronous wheel, the first rotating shaft is in transmission with the synchronous wheel by a second synchronous belt, the first rotating shaft is fixedly connected with a transverse screw rod base, the transverse screw rod base is provided with a transverse screw rod assembly, a second driving motor, a second linear guide rail, a second linear slider, a motor fixing plate and a swing motor, a guiding direction of the second linear guide rail is the same as an orientation of the transverse screw rod assembly, the second linear slider is slidably arranged on the second linear guide rail, the motor fixing plate is arranged on the second linear slider, the swing motor is arranged on the motor fixing plate, and the mechanical arm rocking frame is arranged on a motor shaft of the swing motor.

16. The paint mixing device as claimed in claim 14, wherein the mechanical arm component further comprises a longitudinal driving assembly, the longitudinal driving assembly comprises a longitudinal driving motor, a chain wheel, a driving chain and a counterweight, the chain wheel is arranged on a motor shaft of the longitudinal driving motor, the driving chain is installed on the chain wheel, an end of the driving chain is fixedly connected with the counterweight, and the other end of the driving chain is fixedly connected with the first linear guide rail.

17. The paint mixing device as claimed in claim 10, wherein each color master batch unit comprises a fixing bottom plate, a multi-way valve and a plunger pump, the multi-way valve is arranged on the fixing bottom plate, the plunger pump is arranged on the fixing bottom plate, and communicated with the multi-way valve, and a feeding port of the multi-way valve is provided with a color master batch barrel, and the color master batch barrel is replaceably.

18. The paint mixing device as claimed in claim 17, wherein the punching assembly comprises a punching mechanism bottom plate, a ball screw rod assembly and a lifting card, the ball screw rod assembly is arranged on the punching mechanism bottom plate, the lifting card is arranged on a driving screw nut of the ball screw rod assembly, the plunger pump comprises a pump rod head, the ball screw rod assembly is detachably connected with the plunger pump, and the lifting card is able to drive the pump rod head to move up and down, so a color master batch in the color master batch barrel is quantitatively injected out by the multi-way valve.
